(19) United States
(12) Patent Application Publication
(10) Pub. No.: US 2024/0386714 A1
(43) Pub. Date: Nov. 21, 2024

(54) VIDEO REPRESENTATION SELF-SUPERVISED CONTRASTIVE LEARNING METHOD AND APPARATUS

(71) Applicant: JINGDONG TECHNOLOGY INFORMATION TECHNOLOGY CO., LTD., BEIJING (CN)

(72) Inventors: Yiheng ZHANG, BEIJING (CN); Zhaofan QIU, BEIJING (CN); Ting YAO, BEIJING (CN); Tao MEI, BEIJING (CN)

(21) Appl. No.: 18/692,485

(22) PCT Filed: May 7, 2022
(86) PCT No.: PCT/CN2022/091369

§ 371 Date: Mar. 15, 2024

(30) Foreign Application Priority Data
Sep. 16, 2021 (CN) 202111085396.0

(51) Int. Cl. G06V 10/82; G06N 3/0895; G06T 7/269; G06V 10/74; G06V 10/77; G06V 20/40

(52) U.S. Cl. CPC G06V 10/82; G06N 3/0895; G06T 7/269; G06V 10/761; G06V 10/7715; G06V 20/46; G06T 2207/10016; G06T 2207/20081; G06T 2207/20084

(57) ABSTRACT

The present disclosure relates to the field of video learning. Provided are a video representation self-supervised contrastive learning method and apparatus. The method includes, according to optical flow information corresponding to each video frame of a video clip, obtaining, by means of calculation, a motion amplitude diagram which corresponds to each video frame of the video clip; according to the motion amplitude diagram corresponding to each video frame of the video clip, determining motion information which corresponds to the video clip; and performing video representation self-supervised contrastive learning according to a video clip sequence, and the motion information corresponding to each video clip.

### CROSS-REFERENCE TO RELATED APPLICATIONS

The present application is based on and claims the priority to the Chinese Patent Application No. 202111085396.0 filed on Sep. 16, 2021, the disclosure of which is incorporated herein by reference in its entirety.

### TECHNICAL FIELD

The present disclosure relates to the field of video learning, and in particular, to a video representation self-supervised contrastive learning method and apparatus.

### BACKGROUND

A goal of video representation self-supervised learning is to learn, by exploring inherent attributes present in an unlabeled video, a feature expression of the video.

A video representation self-supervised contrastive learning method, achieves efficient self-supervised video representation learning based on a contrastive learning technology. However, the current video representation self-supervised contrastive learning technology generally concerns how to improve contrastive learning performances according to a research result of image contrastive learning.

### SUMMARY

Some embodiments of the present disclosure provide a video representation self-supervised contrastive learning method, comprising:
calculating, according to optical flow information corresponding to each video frame of a video clip, a motion amplitude map corresponding to each video frame of the video clip;
determining, according to motion amplitude maps corresponding to the video frames of the video clip, motion information corresponding to the video clip; and
performing, according to a sequence of video clips and the motion information corresponding to each video clip, video representation self-supervised contrastive learning.

In some embodiments, the calculating, according to optical flow information corresponding to each video frame of a video clip, a motion amplitude map corresponding to each video frame of the video clip comprises:
extracting an optical flow field between each pair of adjacent video frames in the video clip to determine an optical flow field corresponding to each video frame of the video clip;
calculating gradient fields of the optical flow field corresponding to each video frame in a first direction and a second direction; and
aggregating amplitudes of the gradient fields in the first direction and the second direction to obtain the motion amplitude map corresponding to each video frame.

In some embodiments, the first direction and the second direction are perpendicular to each other.

In some embodiments, the calculating gradient fields of the optical flow field corresponding to each video frame in a first direction and a second direction comprises:
calculating gradients of a horizontal component of the optical flow field corresponding to each video frame in the first direction and the second direction;
calculating gradients of a vertical component of the optical flow field corresponding to each video frame in the first direction and the second direction; and
forming, by the gradients of the horizontal component and the vertical component of the optical flow field corresponding to each video frame in the first direction and the second direction, the gradient fields of the optical flow field in the first direction and the second direction.

In some embodiments, the motion information corresponding to the video clip comprises one or more of a spatiotemporal motion map, a spatial motion map, and a temporal motion map corresponding to the video clip, wherein:
determining the spatiotemporal motion map corresponding to the video clip comprises: superposing, in a temporal dimension, the motion amplitude maps for the video frames of the video clip to form the spatiotemporal motion map for the video clip;
determining the spatial motion map corresponding to the video clip comprises: pooling, along the temporal dimension, the spatiotemporal motion map for the video clip to obtain the spatial motion map for the video clip; or
determining the temporal motion map corresponding to the video clip comprises: pooling, along a spatial dimension, the spatiotemporal motion map for the video clip to obtain the temporal motion map for the video clip.

In some embodiments, the performing, according to a sequence of video clips and the motion information corresponding to each video clip, video representation self-supervised contrastive learning comprises:
performing, according to the motion information corresponding to each video clip, data augmentation on the video clip, and performing video representation self-supervised contrastive learning according to the sequence of augmented video clips and in combination with a contrastive loss; or
performing motion-focused video representation self-supervised contrastive learning according to the sequence of video clips and in combination with a motion alignment loss and a contrastive loss; or
performing, according to the motion information corresponding to each video clip, data augmentation on the video clip, and performing motion-focused video representation self-supervised contrastive learning according to the sequence of augmented video clips and in combination with a motion alignment loss and a contrastive loss,
wherein the motion alignment loss is determined by aligning an output of a last convolutional layer of a backbone network performing learning with the motion information corresponding to the video clip.

In some embodiments, the performing, according to the motion information corresponding to each video clip, data augmentation on the video clip comprises:
in a case where the motion information corresponding to the video clip comprises a spatiotemporal motion map corresponding to the video clip, determining a first threshold according to motion velocity magnitudes of pixels in the spatiotemporal motion map, and determining a three-dimensional spatiotemporal area with a significant motion amplitude in the video clip according to the first threshold; or
in a case where the motion information corresponding to the video clip comprises a temporal motion map corresponding to the video clip, calculating a motion amplitude of the video clip according to the temporal motion map corresponding to the video clip, and performing temporal sampling on each video clip in the sequence, wherein a motion amplitude of the sampled video clip is not less than a second threshold determined from the motion amplitudes of the video clips; or
in a case where the motion information corresponding to the video clip comprises a spatial motion map corresponding to the video clip, determining a third threshold according to motion velocity magnitudes of pixels in the spatial motion map corresponding to the video clip, dividing the pixels according to the third threshold, repeatedly performing random multi-scale spatial cropping on the spatial motion map, and ensuring that a cropped rectangular spatial area covers at least pixels greater than the third threshold in the spatial motion map that exceeds a preset proportion, wherein an area same as the rectangular spatial area is cropped for each video frame in the video clip.

In some embodiments, the calculating a motion amplitude of the video clip according to the temporal motion map corresponding to the video clip comprises:
taking the temporal motion map corresponding to the video clip as a video-frame-level motion map, and calculating a mean of video-frame-level motion maps of all the frames within the video clip as the motion amplitude of the video clip.

In some embodiments, the first threshold, the second threshold, and the third threshold are respectively determined by using a median.

In some embodiments, the performing data augmentation on the video clip further comprises: performing an image data augmentation operation on the video frame in the video clip.

In some embodiments, a loss function corresponding to the motion alignment loss is represented as one or an accumulation of more of the following:
a distance between an accumulation of a feature map output by the last convolutional layer of the backbone network in all channels and a spatiotemporal motion map corresponding to the video clip;
a distance between a pooling result of the accumulation along the temporal dimension and a spatial motion map corresponding to the video clip; or
a distance between a pooling result of the accumulation along the spatial dimension and a temporal motion map corresponding to the video clip.

In some embodiments, a loss function corresponding to the motion alignment loss is represented as one or an accumulation of more of the following:
a distance between a first weighted accumulation of a feature map output by the last convolutional layer of the backbone network in all channels according to weights of the channels and a spatiotemporal motion map corresponding to the video clip;
a distance between a pooling result of the first weighted accumulation along the temporal dimension and a spatial motion map corresponding to the video clip; or
a distance between a pooling result of the first weighted accumulation along the spatial dimension and a temporal motion map corresponding to the video clip.

In some embodiments, a loss function corresponding to the motion alignment loss is represented as one or an accumulation of more of the following:
a distance between a second weighted accumulation of gradients of channels of a feature map output by the last convolutional layer of the backbone network in all the channels according to weights of the channels and a spatiotemporal motion map corresponding to the video clip;
a distance between a pooling result of the second weighted accumulation along the temporal dimension and a spatial motion map corresponding to the video clip; or
a distance between a pooling result of the second weighted accumulation along the spatial dimension and a temporal motion map corresponding to the video clip.

In some embodiments, the weight of the channel is determined by: calculating a gradient of a similarity between a query sample and a positive sample corresponding to the video clip with respect to a channel of the feature map output by the convolutional layer, and calculating a mean of the gradient of the channel as the weight of the channel.

In some embodiments, the contrastive loss is determined according to a loss function for the contrastive learning.

In some embodiments, the loss function for the contrastive learning comprises an InfoNCE loss function.

In some embodiments, the backbone network comprises a three-dimensional convolutional neural network.

In some embodiments, the method further comprises: processing a video to be processed according to a learned video representation model to obtain a corresponding video feature.

Some embodiments of the present disclosure provide a video representation self-supervised contrastive learning apparatus, comprising: a memory; and a processor coupled to the memory, the processor being configured to perform, based on instructions stored in the memory, the video representation self-supervised contrastive learning method.

Some embodiments of the present disclosure provide a non-transitory computer-readable storage medium stored a computer program which, when executed by a processor, implements the steps of the video representation self-supervised contrastive learning method.

### BRIEF DESCRIPTION OF THE DRAWINGS

The accompanying drawings that need to be used in the description of the embodiments or the related art will be briefly described below. The present disclosure will be more clearly understood according to the following detailed description, which proceeds with reference to the accompanying drawings.

Obviously, the drawings in the following description are merely some embodiments of the present disclosure, and for one of ordinary skill in the art, other drawings may obtained according to these drawings without paying inventive labor.

FIG. 1 illustrates a flow diagram of a motion-focused video representation self-supervised contrastive learning method according to some embodiments of the present disclosure.

FIGS. 2a, 2b, 2c, and 2d illustrate schematic diagrams of extracting motion information of a video clip and video augmentation based on the motion information according to some embodiments of the present disclosure.

FIG. 3 illustrates a schematic diagram of performing video representation self-supervised contrastive learning simultaneously by a combination of motion-focused video augmentation and motion-focused feature learning according to the present disclosure.

FIG. 4 illustrates an alignment diagram of a motion alignment loss function according to some embodiments of the present disclosure.

FIG. 5 is a schematic structural diagram of a motion-focused video representation self-supervised contrastive learning apparatus according to some embodiments of the present disclosure.

### DETAILED DESCRIPTION

The technical solutions in the embodiments of the present disclosure will be clearly and completely described below in conjunction with the drawings in the embodiments of the present disclosure.

Unless specifically stated, terms such as “first”, “second”, in this disclosure are used for distinguishing different objects, but not used for indicating a meaning such as size or sequence.

It is found that, the current video representation self-supervised contrastive learning technology generally focuses on how to improve contrastive learning performances according to a research result of image contrastive learning, so that a most crucial temporal-dimension difference between video and image is often ignored, as a result, motion information widely existing in the video is not fully valued and based, but in an actual scenario, semantic information and motion information of the video are highly correlated.

The present disclosure provides a motion-focused contrastive learning solution for video representation self-supervised learning, so that the motion information which widely exists in the video and is very important is fully utilized in the learning process, thereby improving the video representation self-supervised contrastive learning performance.

FIG. 1 illustrates a flow diagram of a motion-focused video representation self-supervised contrastive learning method according to some embodiments of the present disclosure.

As shown in FIG. 1, the method of this embodiment comprises: steps 110 to 130.

In step 110, according to optical flow information corresponding to each video frame of a video clip, a motion amplitude map corresponding to each video frame of the video clip is calculated.

In the video, motion in different areas is essentially different. A position change rate of each area in the video frame with respect to a reference frame is measured by using a motion velocity magnitude (i.e., a motion amplitude). Generally, an area with a greater velocity has richer information and is more conducive to contrastive learning.

In some embodiments, this step 110 includes, for example: steps 111 to 113.

In step 111, an optical flow field between each pair of adjacent video frames in the video clip is extracted to determine an optical flow field corresponding to each video frame of the video clip.

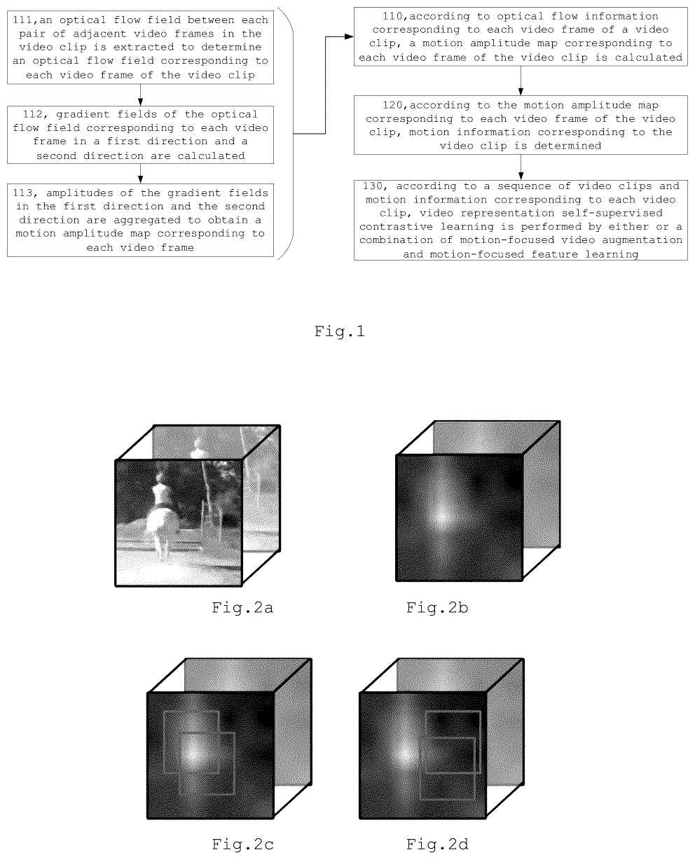

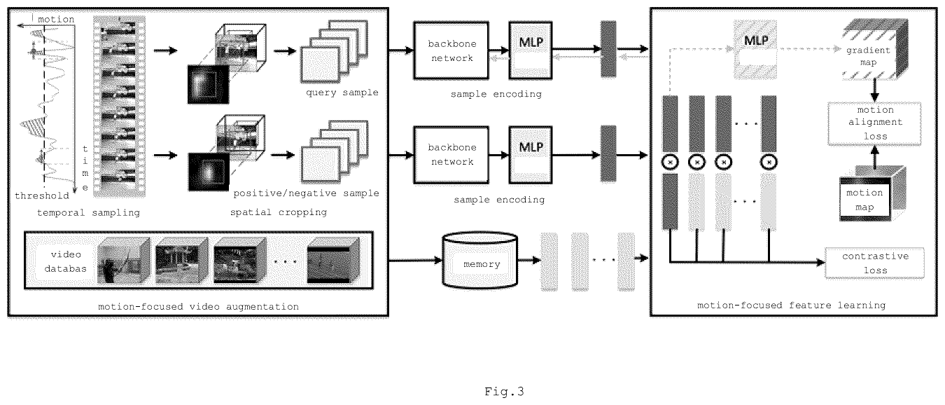

For a video clip (as shown in FIG. 2a, where a video image is only an example, so that the content of the video image is not protected in the present application) with N frames of resolution of H×W, an optical flow field between each pair of adjacent video frames is extracted according to an unsupervised TV-L1 algorithm, to determine an optical flow field corresponding to each video frame of the video clip, denoted as {(u₁, v₁), (u₂, v₂), . . . , (u_{N}, v_{N})}. uᵢ, vᵢ respectively are components of the optical flow field in a horizontal direction and a vertical direction, for representing a displacement of each pixel between an i-th frame and an (i+1)-th frame that has the resolution of H×W.

The optical flow field refers to a two-dimensional instantaneous velocity field formed by all pixel points in an image, wherein the two-dimensional velocity vector is a projection of a three-dimensional velocity vector of a visible point in a scene on an imaging surface.

In step 112, gradient fields of the optical flow field corresponding to each video frame in a first direction and a second direction are calculated.

In the process of calculating the motion amplitude according to the optical flow, due to influence of motion of a camera, calculating the motion amplitude directly according to the optical flow is likely to encounter a stability problem. For example, when the camera is in rapid motion, an originally stationary object or background pixels may exhibit a very high motion velocity in the optical flow, which is disadvantageous for obtaining high-quality motion information of the video content. In order to eliminate the instability problem caused by camera lens shake, the gradient fields of the optical flow field in the first direction and the second direction are further calculated as motion boundaries.

In some embodiments, the calculating gradient fields of the optical flow field corresponding to each video frame in a first direction and a second direction comprises: calculating gradients of a horizontal component of the optical flow field corresponding to each video frame in the first direction and the second direction; calculating gradients of a vertical component of the optical flow field corresponding to each video frame in the first direction and the second direction; forming, by the gradients of the horizontal component and the vertical component of the optical flow field corresponding to each video frame in the first direction and the second direction, the gradient fields of the optical flow field in the first direction and the second direction. In some embodiments, the first direction and the second direction may be perpendicular to each other. For example, an x direction and a y direction perpendicular to each other in an coordinate system are taken as the first direction and the second direction.

Gradient information of the optical flow field

corresponding to each video frame in the x direction and the y direction is calculated as the motion boundary. For example, for the optical flow field (uᵢ, vᵢ) of the i-th frame, its gradient fields

$$( \frac{\partial {u}_{i}}{\partial x} , \frac{\partial {u}_{i}}{\partial y} , \frac{\partial {v}_{i}}{\partial x} , \frac{\partial {v}_{i}}{\partial y} )$$

in the x direction and the y direction may be calculated.

In step 113, amplitudes of the gradient fields in the first direction and the second direction are aggregated to obtain a motion amplitude map corresponding to each video frame.

Based on the above gradient fields, the amplitudes of the gradient fields in various directions can be further aggregated to obtain a motion amplitude map mᵢ of the i-th frame (FIG. 2b):

$${m}_{i} = \sqrt{{( \frac{\partial {u}_{i}}{\partial x} )}^{2} + {( \frac{\partial {u}_{i}}{\partial y} )}^{2} + {( \frac{\partial {v}_{i}}{\partial x} )}^{2} + {( \frac{\partial {v}_{i}}{\partial y} )}^{2}}$$

where mᵢ∈ [symbol] H×W is used for representing a motion velocity magnitude (i.e. motion amplitude) of each pixel in the i-th frame, with direction information of the motion omitted. As shown in FIG. 2b, the motion amplitude map defined in the present disclosure is not affected by the motion of the camera, so that a high response is shown to a de facto motion object in the video clip, wherein a highlighted part corresponds to the motion object.

In step 120, according to the motion amplitude map corresponding to each video frame of the video clip, motion information corresponding to the video clip is determined.

The motion information corresponding to the video clip comprises: one or more of a spatiotemporal motion map (m^{ST}∈ [symbol] ^{N×H×W}, ST-motion), a spatial motion map (m^{S}∈ [symbol] ^{H×W}, S-motion), and a temporal motion map (m^{T}∈ [symbol] ^{N}, T-motion) corresponding to the video clip.

Determining the spatiotemporal motion map corresponding to the video clip comprises: superimposing, in a temporal dimension, the motion amplitude maps for the video frames of the video clip to form the spatiotemporal motion map for the video clip. For example, for the video clip with a length of N frames, the motion amplitude maps mᵢ for the video frames of the video clip are superimposed in the temporal dimension to form the spatiotemporal motion map m^{ST}.

Determining the spatial motion map corresponding to the video clip comprises: pooling, along the temporal dimension, the spatiotemporal motion map for the video clip to obtain the spatial motion map for the video clip. For example, m^{ST}∈ [symbol] ^{N×H×W} is pooled along the temporal dimension to obtain the spatial motion map m^{S}∈ [symbol] ^{H×W} for the video clip.

Determining the temporal motion map corresponding to the video clip comprises: pooling, along a spatial dimension, the spatiotemporal motion map for the video clip to obtain the temporal motion map for the video clip. For example, m^{ST}∈ [symbol] ^{N×H×W} pooled along the spatial dimension to obtain the temporal motion map m^{T}∈ [symbol] ^{N} for the video clip.

In step 130, according to a sequence of video clips and motion information corresponding to each video clip, video representation self-supervised contrastive learning is performed by either or a combination of motion-focused video augmentation and motion-focused feature learning. The performance in the video representation self-supervised contrastive learning task is improved.

FIG. 3 illustrates a schematic diagram of performing video representation self-supervised contrastive learning simultaneously by a combination of motion-focused video augmentation and motion-focused feature learning according to the present disclosure.

The motion-focused video augmentation can, according to the pre-calculated video motion map, generate a three-dimensional pipeline with rich motion information as an input to a backbone network. The three-dimensional pipeline refers to video samples formed by stitching image blocks sampled from a series of consecutive video frames together in the temporal dimension. The motion-focused video augmentation can be divided into two parts: 1) temporal sampling for filtering out a temporal video clip with a relatively still screen, and 2) spatial cropping for selecting a spatial area with a significant motion velocity in the video. Because of correlation between video semantics and motion information in the video, video samples with more relevant semantics that contain rich motion information are generated by the motion-focused video augmentation.

The motion-focused feature learning is implemented by a new motion alignment loss provided in the present disclosure, in which a gradient amplitude corresponding to each position in the input video sample (three-dimensional pipeline) is aligned with a motion map in an optimization process that a random gradient drops, to help the backbone network to more concern an area with higher dynamic information in the video in the process of the feature learning. On the basis of a contrastive learning loss (e.g., InfoNCE loss), the motion alignment loss is integrated into the contrastive learning framework in a form of an additional constraint. Finally, the entire motion-focused contrastive learning framework is jointly optimized in an end-to-end manner. The backbone network comprises a three-dimensional convolutional neural network, such as a three-dimensional resnet, but is not limited to the illustrated example. A multilayer perceptron (MLP) and the like can also be cascaded behind the backbone network. The motion-focused feature learning enables focusing more on the motion area in the video in the learning process, and therefore enables the learned video feature to contain sufficient motion information, to better describe the content in the video.

That is, this step 130 includes the following three implementations.

The first one is performing motion-focused video augmentation: performing, according to the motion information corresponding to each video clip, data augmentation on the video clip, and performing video representation self-supervised contrastive learning according to the sequence of augmented video clips and in combination with a contrastive loss, namely, for the sequence of augmented video clips, performing video representation self-supervised contrastive learning by using the contrastive loss.

The second one is performing motion-focused feature learning: performing motion-focused video representation self-supervised contrastive learning according to the sequence of video clips and in combination with a motion alignment loss and a contrastive loss, namely, for the sequence of video clips, performing motion-focused video representation self-supervised contrastive learning by using the motion alignment loss and the contrastive loss.

The third one is performing motion-focused video augmentation and motion-focused feature learning simultaneously: performing, according to the motion information corresponding to each video clip, data augmentation on the video clip, and performing motion-focused video representation self-supervised contrastive learning according to the sequence of augmented video clips and in combination with a motion alignment loss and a contrastive loss, namely, for the sequence of augmented video clips, performing motion-focused video representation self-supervised contrastive learning by using the motion alignment loss and the contrastive loss.

The motion alignment loss is determined by aligning an output of a last convolutional layer of the backbone network performing the learning with the motion information corresponding to the video clip. The contrastive loss is determined according to a loss function for the contrastive learning. The loss function for contrastive learning includes, for example, an InfoNCE loss function, etc., but is not limited to the illustrated example. The motion alignment loss and contrastive loss will be described specifically later.

The motion-focused video augmentation will be described below.

Based on the various motion maps of the video clip described above, the motion-focused video augmentation may better focus on the areas with significant motion in the video. A better data view is selected for a contrastive learning algorithm, whereby the generalization capability of the video representation learned by the model is improved. This is because the self-supervised learning method based on the contrastive learning can often benefit better from mutual information (MI) between the data views, and in order to improve the generalization capability of the model for a downstream task, a “good” view should contain as much information relevant to the downstream task as possible while discarding as much irrelevant information in the input as possible. Considering that most downstream tasks related to the video require the motion information in the video, for example, in FIG. 2c, by rectangular boxes, two video area samples containing a significant motion amplitude are labeled, where a horse and rider in motion contain more valuable mutual information, and in FIG. 2d, by rectangular boxes, two samples sampled from static areas in the video are labeled, where relatively less important background information such as shrubs and ground is contained, etc., so that the samples in FIG. 2c are more helpful to improve the effect of the contrastive learning of the model. According to the present disclosure, a video spatiotemporal area containing more motion information is sought according to the motion maps that are available without manual labeling.

In some embodiments, the performing, according to the motion information corresponding to each video clip, data augmentation on the video clip comprises at least three implementations as follows.

A first one is, in a case where the motion information corresponding to the video clip comprises a spatiotemporal motion map corresponding to the video clip, determining a first threshold according to motion velocity magnitudes of pixels in the spatiotemporal motion map, wherein the first threshold may be determined by using a median, for example, determining a median of the motion velocity magnitudes of the pixels in the spatiotemporal motion map as the first threshold, and then determining a three-dimensional spatiotemporal area with a significant motion amplitude in the video clip according to the first threshold, for example, the three-dimensional spatiotemporal area covering at least pixels greater than the first threshold in the spatiotemporal motion map that exceeds a preset proportion (e.g., 80%).

Therefore, the three-dimensional spatiotemporal area with significant motion in the video is directly obtained by the spatiotemporal motion map.

A second one is, in a case where the motion information corresponding to the video clip comprises a temporal motion map corresponding to the video clip, calculating the motion amplitude of the video clip according to the temporal motion map corresponding to the video clip, for example, taking the temporal motion map corresponding to the video clip as a video-frame-level motion map, calculating a mean of video-frame-level motion maps of all the frames within the video clip as the motion amplitude of the video clip, and then performing temporal sampling on each video clip in the sequence of video clips, wherein a motion amplitude of the sampled video clip is not less than a second threshold, and a video clip with a motion amplitude less than the second threshold may not be sampled. The second threshold is determined according to the motion amplitudes of the video clips, for example, taking a median of the motion amplitudes of the video clips as the second threshold.

Therefore, by the temporal sampling based on the temporal motion map, the video clip with significant motion in the sequence of video clips can be extracted.

A third one is, in a case where the motion information corresponding to the video clip comprises a spatial motion map corresponding to the video clip, determining a third threshold according to motion velocity magnitudes of pixels in the spatial motion map corresponding to the video clip, dividing the pixels according to the third threshold, repeatedly performing random multi-scale spatial cropping on the spatial motion map, and ensuring that a cropped rectangular spatial area covers at least pixels greater than the third threshold in the spatial motion map that exceeds a preset proportion, wherein an area same as the rectangular spatial area is cropped for each video frame in the video clip.

Therefore, by the spatial cropping based on the spatial motion map, the three-dimensional spatiotemporal area with significant motion in the video clip can be obtained.

The second and third ones described above may also be used in combination. That is, under the guidance of the motion map, the motion-focused video augmentation samples the original video data sequentially by the two steps of temporal sampling and spatial cropping. Because half of candidate video clips can be filtered out in the temporal sampling, objects to be processed in the spatial cropping are reduced, and the efficiency of the video augmentation is improved.

After the motion-focused video augmentation, image data augmentation operations such as color dithering, random graying, random blurring and random mirroring, are performed on the video frames in the video clip. Therefore, randomness in a traditional video augmentation method is maintained.

The motion-focused feature learning will be described below.

By using the motion map extracted from the video as a supervision signal for the feature learning of the model, the contrastive learning process of the model is further guided, such as performing motion-focused video representation self-supervised contrastive learning in combination with the motion alignment loss and the contrastive loss as described above. That is, a loss function of the motion-focused video representation self-supervised contrastive learning is [symbol] = [symbol] _{MAL}+ [symbol] _{NCE}, where [symbol] _{MAL} represents a motion alignment loss function, for example, candidate [symbol] _{MAL-v1}, [symbol] _{MAL-v2}, or [symbol] _{MAL-v3}, and [symbol] _{NCE} represents a contrastive loss function, for example, InfoNCE.

In conventional contrastive learning, one encoder-encoded query sample q∈ [symbol] ^{d} and a set of encoder-encoded key value vectors containing one positive-sample key value k⁺∈ [symbol] ^{d} and K negative-sample key values [symbol] ^{-={k}ᵢ⁻} are given. The query sample and the positive sample are usually samples obtained after a different data augmentation is performed on one same data instance (image, video, etc.), and a negative sample is a sample sampled from other different data instances. A goal of an instance discrimination task in the contrastive learning is to guide that the query sample q is more similar to the positive sample k⁺ in a feature space, and simultaneously ensure that enough discrimination exists between the query sample q and other negative samples [symbol] ⁻. The contrastive learning generally uses InfoNCE as its loss function:

$${ℒ}_{NCE} = - log \frac{exp ( {q}^{T} {k}^{+} / τ )}{exp ( {q}^{T} {k}^{+} / τ ) + {\sum }_{i = 1}^{K} exp ( {q}^{T} {k}_{i}^{-} / τ )}$$

where τ is a preset hyper-parameter.

The loss function for the contrastive learning is performing contrastive learning at a level of an encoded video sample (three-dimensional pipeline), in which each temporal-spatial position in the three-dimensional pipeline is treated equally. Considering that semantic information in the video is more concentrated in an area with intense motion, in order to help the model to focus more on the motion area in the video in the training process to better discover the motion information in the video, the present disclosure provides a new motion alignment loss (MAL) to align the output of the convolutional layer of the backbone network with the motion amplitude in the motion map for the video sample, and act on an optimization process of the model as a supervision signal other than InfoNCE, thereby enabling the learned video feature expression to better describe the motion information in the video.

Hereinafter, description is made to the loss functions corresponding to the three motion alignment losses, called motion alignment loss functions for short.

A first motion alignment loss function is to align the feature map, i.e., to align an amplitude of the feature map output by the last convolutional layer of the backbone network with the motion map, so that the feature map for the convolutional layer output by the backbone network has a greater response in the area with significant motion.

The first motion alignment loss function is represented as one or an accumulation of more of the following: a distance between an accumulation of the feature map output by the last convolutional layer of the backbone network in all channels and the spatiotemporal motion map corresponding to the video clip, a distance between a pooling result of the accumulation along the temporal dimension and the spatial motion map corresponding to the video clip, and a distance between a pooling result of the accumulation along the spatial dimension and the temporal motion map corresponding to the video clip.

When the above three distances are included, the first motion alignment loss function is represented as:

$${ℒ}_{MAL - v 1} = {‖ {h}^{ST} - 〈 {m}^{ST} 〉 ‖}_{2}^{2} + {‖ {h}^{S} - 〈 {m}^{S} 〉 ‖}_{2}^{2} + {‖ {h}^{T} - 〈 {m}^{T} 〉 ‖}_{2}^{2}$$

where h^{ST}= [symbol] Σ_{c}h_{c} [symbol] , h_{c} represents a response amplitude of a c-th channel of the feature map output by the convolutional layer, Σ_{c}h_{c} represents the accumulation of the response amplitudes of the feature map output by the convolutional layer in all the channels, a pooling result of h^{ST} along the temporal dimension is represented as h^{S}, a pooling result of h^{ST} along the spatial dimension is represented as h^{T} , m^{ST} represents the spatiotemporal motion map, m^{S} represents the spatial motion map, and m^{T} represents the temporal motion map.

A second motion alignment loss function is to align a weighted feature map, i.e. to align a weighted accumulation of the feature map output by the last convolutional layer of the backbone network in all channels according to weights of the channels, with the motion map.

Considering that a gradient amplitude corresponding to the feature map can better measure a contribution of a feature of each position in the feature map to a model inference result, i.e., the contrastive learning loss function InfoNCE, a response to the feature map can be weighted by using the gradient amplitude. The weight of the channel is determined by: calculating a gradient of a similarity between the query sample and the positive sample corresponding to the video clip with respect to a channel of the feature map output by the convolutional layer, and calculating a mean of the gradient of the channel as the weight of the channel. Specifically, according to the form of the InfoNCE loss function, firstly, the gradient

$${g}_{c} = \frac{\partial {q}^{T} {k}^{+}}{\partial {h}_{c}}$$

of the similarity q^{T}k⁺ between the query sample and the positive sample with respect to a channel of the feature map output by the convolutional layer needs to be calculated, then, for each channel c, the mean w_{c} of the gradient g_{c} is calculated for representing the weight of the channel c, and finally, channel dimension weighting is performed on the feature map by using the weights of the channels.

The second motion alignment loss function is represented as one or an accumulation of more of the following: a distance between a first weighted accumulation of a feature map output by the last convolutional layer of the backbone network in all channels according to weights of the channels and a spatiotemporal motion map corresponding to the video clip, a distance between a pooling result of the first weighted accumulation along the temporal dimension and a spatial motion map corresponding to the video clip, and a distance between a pooling result of the first weighted accumulation along the spatial dimension and a temporal motion map corresponding to the video clip.

When the above three distances are included, the second motion alignment loss function is represented as:

$${ℒ}_{MAL - v 2} = {‖ {\overline{h}}^{ST} - 〈 {m}^{ST} 〉 ‖}_{2}^{2} + {‖ {\overline{h}}^{S} - 〈 {m}^{S} 〉 ‖}_{2}^{2} + {‖ {\overline{h}}^{T} - 〈 {m}^{T} 〉 ‖}_{2}^{2}$$

where h̅^{ST}= [symbol] ReLU(Σ_{c}w_{c}h_{c}) [symbol] , h_{c} represents the response amplitude of the c-th channel of the feature map output by the convolutional layer, w_{c} represents a weight of the c-th channel, ReLU represents a rectified linear unit, a pooling result of h̅^{ST} along the temporal dimension is represented as h̅^{S}, a pooling result of h̅^{ST} along the spatial dimension is represented as h̅^{T}, m^{ST} represents the spatiotemporal motion map, m^{S} represents the spatial motion map, and m^{T} represents the temporal motion map.

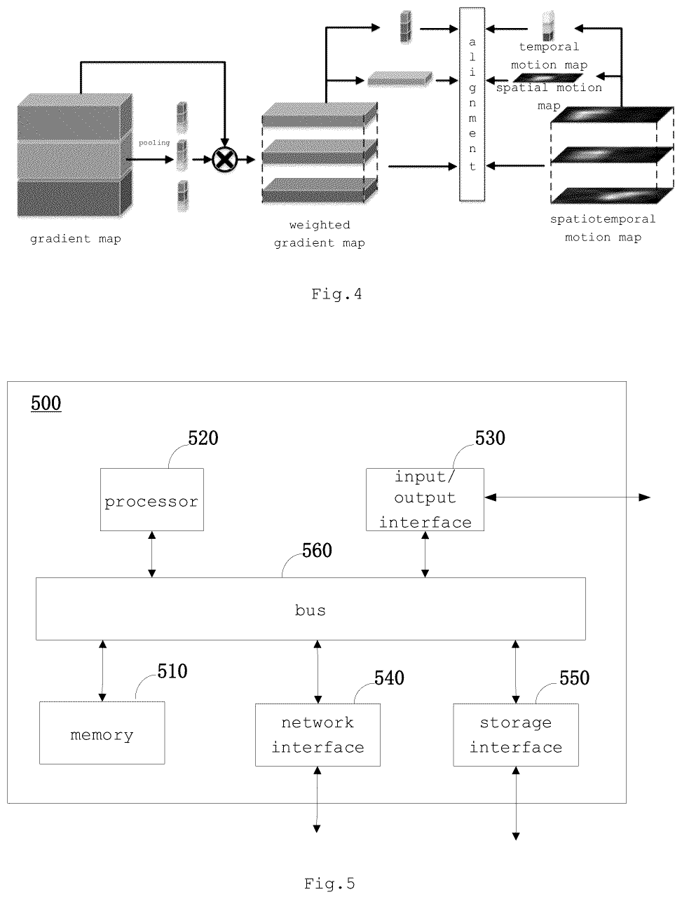

A third motion alignment loss function is to align a weighted gradient map, i.e., to align a weighted accumulation of gradients of channels of the feature map output by the last convolutional layer of the backbone network in all the channels according to the weights of the channels, with the motion map, as shown in FIG. 4.

The third motion alignment loss function is represented as one or an accumulation of more of the following: a distance between a second weighted accumulation of gradients of channels of a feature map output by the last convolutional layer of the backbone network in all the channels according to weights of the channels and a spatiotemporal motion map corresponding to the video clip, a distance between a pooling result of the second weighted accumulation along the temporal dimension and a spatial motion map corresponding to the video clip, and a distance between a pooling result of the second weighted accumulation along the spatial dimension and a temporal motion map corresponding to the video clip. For the calculation of the weights of the channels, reference is made to the forgoing description.

When the above three distances are included, the third motion alignment loss function is represented as:

$${ℒ}_{MAL - v 3} = {‖ {\overline{g}}^{ST} - 〈 {m}^{ST} 〉 ‖}_{2}^{2} + {‖ {\overline{g}}^{S} - 〈 {m}^{S} 〉 ‖}_{2}^{2} + {‖ {\overline{g}}^{T} - 〈 {m}^{T} 〉 ‖}_{2}^{2}$$

where g̅^{ST}= [symbol] ReLU (Σ_{c}w_{c}g_{c}) [symbol] , a pooling result of g̅^{ST} along the temporal dimension is represented as g̅^{S}, a pooling result of g̅^{ST} along the spatial dimension is represented as g̅^{T}, m^{ST} represents the spatiotemporal motion map, m^{S} represents the spatial motion map, and m^{T} represents the temporal motion map, and the meanings of w_{c} and g_{c} refer to the forgoing description.

Through the above embodiments, the video representation model is learned, and a video to be processed is processed according to the learned video representation model to obtain a corresponding video feature.

FIG. 5 is a schematic structural diagram of a motion-focused video representation self-supervised contrastive learning apparatus according to some embodiments of the present disclosure.

As shown in FIG. 5, the apparatus 500 of this embodiment comprises: a memory 510 and a processor 520 coupled to the memory 510, the processor 520 being configured to perform, based on instructions stored in the memory 510, the motion-focused video representation self-supervised contrastive learning method according to any of the foregoing embodiments.

The memory 510 may include, for example, a system memory, a fixed non-volatile storage medium, and the like. The system memory has thereon stored, for example, an operating system, an application, a boot loader, other programs, and the like.

The processor 520 may be implemented by a discrete hardware component such as a general-purpose processor, a digital signal processor (DSP), an application specific integrated circuit (ASIC), a field programmable gate array (FPGA) or other programmable logic devices, a discrete gate or transistor.

The apparatus 500 may further include an input/output interface 530, a network interface 540, a storage interface 550, and the like. These interfaces 530, 540, 550 and the memory 510 may be connected with the processor 520, for example, via a bus 560. The input/output interface 530 provides a connection interface for input/output devices such as a display, a mouse, a keyboard, and a touch screen. The network interface 540 provides a connection interface for various networking devices. The storage interface 550 provides a connection interface for external storage devices such as an SD card and a USB flash disk. The bus 560 may use any of a variety of bus architectures. For example, the bus structure includes, but is not limited to, an industry standard architecture (ISA) bus, a micro channel architecture (MCA) bus, and a peripheral component interconnect (PCI) bus.

It should be appreciated by those skilled in the art that, the embodiments of the present disclosure may be provided as a method, system, or computer program product. Accordingly, the present disclosure may take a form of an entire hardware embodiment, an entire software embodiment, or an embodiment combining software and hardware aspects. Moreover, the present disclosure may take a form of a computer program product implemented on one or more non-transitory computer-readable storage media (including, but not limited to, a disk memory, CD-ROM, optical memory, etc.) having computer program code embodied therein.

The present disclosure is described with reference to flow diagrams and/or block diagrams of the method, apparatus (system) and computer program product according to the embodiments of the present disclosure. It should be understood that each flow and/or block of the flow diagrams and/or block diagrams, and a combination of flows and/or blocks in the flow diagrams and/or block diagrams, can be implemented by computer program instructions. These computer program instructions may be provided to a processor of a general-purpose computer, special-purpose computer, embedded processor, or other programmable data processing devices to produce a machine, such that the instructions which are executed through the processor of the computer or other programmable data processing devices create means for implementing the functions specified in one or more flows of the flow diagrams and/or one or more blocks of the block diagrams.

These computer program instructions may also be stored in a computer-readable memory that can guide a computer or other programmable data processing devices to work in a specific manner, such that the instructions stored in the computer-readable memory produce an article of manufacture including instruction means which implement the functions specified in one or more flows of the flow diagrams and/or one or more blocks of the block diagrams.

These computer program instructions may also be loaded onto a computer or other programmable data processing devices to cause a series of operational steps to be performed on the computer or other programmable devices to produce a computer-implemented process, such that the instructions which are executed on the computer or other programmable devices provide steps for implementing the functions specified in one or more flows of the flow diagrams and/or one or more blocks of the block diagrams.

The above merely describes the preferred embodiments of the present disclosure and is not intended to limit the present disclosure, and any modifications, equivalent substitutions, improvements and the like that are made within the spirit and principle of the present disclosure are intended to be included within the scope of protection of the present disclosure.

1. A video representation self-supervised contrastive learning method, comprising:
calculating, according to optical flow information corresponding to each video frame of a video clip, a motion amplitude map corresponding to each video frame of the video clip;
determining, according to motion amplitude maps corresponding to the video frames of the video clip, motion information corresponding to the video clip; and
performing, according to a sequence of video clips and the motion information corresponding to each video clip, video representation self-supervised contrastive learning.

2. The video representation self-supervised contrastive learning method according to claim 1, wherein the calculating, according to optical flow information corresponding to each video frame of a video clip, a motion amplitude map corresponding to each video frame of the video clip comprises:
extracting an optical flow field between each pair of adjacent video frames in the video clip to determine an optical flow field corresponding to each video frame of the video clip;
calculating gradient fields of the optical flow field corresponding to each video frame in a first direction and a second direction; and
aggregating amplitudes of the gradient fields in the first direction and the second direction to obtain the motion amplitude map corresponding to each video frame.

3. The video representation self-supervised contrastive learning method according to claim 2, wherein the first direction and the second direction are perpendicular to each other.

4. The video representation self-supervised contrastive learning method according to claim 2, wherein the calculating gradient fields of the optical flow field corresponding to each video frame in a first direction and a second direction comprises:
calculating gradients of a horizontal component of the optical flow field corresponding to each video frame in the first direction and the second direction;
calculating gradients of a vertical component of the optical flow field corresponding to each video frame in the first direction and the second direction; and
forming, by the gradients of the horizontal component and the vertical component of the optical flow field corresponding to each video frame in the first direction and the second direction, the gradient fields of the optical flow field in the first direction and the second direction.

5. The video representation self-supervised contrastive learning method according to claim 1, wherein the motion information corresponding to the video clip comprises one or more of a spatiotemporal motion map, a spatial motion map, and a temporal motion map corresponding to the video clip, wherein:
determining the spatiotemporal motion map corresponding to the video clip comprises: superposing, in a temporal dimension, the motion amplitude maps for the video frames of the video clip to form the spatiotemporal motion map for the video clip;
determining the spatial motion map corresponding to the video clip comprises: pooling, along the temporal dimension, the spatiotemporal motion map for the video clip to obtain the spatial motion map for the video clip; or
determining the temporal motion map corresponding to the video clip comprises: pooling, along a spatial dimension, the spatiotemporal motion map for the video clip to obtain the temporal motion map for the video clip.

6. The video representation self-supervised contrastive learning method according to claim 1, wherein the performing, according to a sequence of video clips and the motion information corresponding to each video clip, video representation self-supervised contrastive learning comprises:
performing, according to the motion information corresponding to each video clip, data augmentation on the video clip, and performing video representation self-supervised contrastive learning according to the sequence of augmented video clips and in combination with a contrastive loss; or
performing motion-focused video representation self-supervised contrastive learning according to the sequence of video clips and in combination with a motion alignment loss and a contrastive loss; or
performing, according to the motion information corresponding to each video clip, data augmentation on the video clip, and performing motion-focused video representation self-supervised contrastive learning according to the sequence of augmented video clips and in combination with a motion alignment loss and a contrastive loss,
wherein the motion alignment loss is determined by aligning an output of a last convolutional layer of a backbone network performing learning with the motion information corresponding to the video clip.

7. The video representation self-supervised contrastive learning method according to claim 6, wherein the performing, according to the motion information corresponding to each video clip, data augmentation on the video clip comprises:
in a case where the motion information corresponding to the video clip comprises a spatiotemporal motion map corresponding to the video clip, determining a first threshold according to motion velocity magnitudes of pixels in the spatiotemporal motion map, and determining a three-dimensional spatiotemporal area with a significant motion amplitude in the video clip according to the first threshold; or
in a case where the motion information corresponding to the video clip comprises a temporal motion map corresponding to the video clip, calculating a motion amplitude of the video clip according to the temporal motion map corresponding to the video clip, and performing temporal sampling on each video clip in the sequence, wherein a motion amplitude of the sampled video clip is not less than a second threshold determined from the motion amplitudes of the video clips; or
in a case where the motion information corresponding to the video clip comprises a spatial motion map corresponding to the video clip, determining a third threshold according to motion velocity magnitudes of pixels in the spatial motion map corresponding to the video clip, dividing the pixels according to the third threshold, repeatedly performing random multi-scale spatial cropping on the spatial motion map, and ensuring that a cropped rectangular spatial area covers at least pixels greater than the third threshold in the spatial motion map that exceeds a preset proportion, wherein an area same as the rectangular spatial area is cropped for each video frame in the video clip.

8. The video representation self-supervised contrastive learning method according to claim 7, wherein the calculating a motion amplitude of the video clip according to the temporal motion map corresponding to the video clip comprises:
taking the temporal motion map corresponding to the video clip as a video-frame-level motion map, and calculating a mean of video-frame-level motion maps of all the frames within the video clip as the motion amplitude of the video clip.

9. The video representation self-supervised contrastive learning method according to claim 7, wherein the first threshold, the second threshold, and the third threshold are respectively determined by using a median.

10. The video representation self-supervised contrastive learning method according to claim 7, wherein the performing data augmentation on the video clip further comprises:
performing an image data augmentation operation on the video frame in the video clip.

11. The video representation self-supervised contrastive learning method according to claim 6, wherein a loss function corresponding to the motion alignment loss is represented as one or an accumulation of more of the following:
a distance between an accumulation of a feature map output by the last convolutional layer of the backbone network in all channels and a spatiotemporal motion map corresponding to the video clip;
a distance between a pooling result of the accumulation along the temporal dimension and a spatial motion map corresponding to the video clip; or
a distance between a pooling result of the accumulation along the spatial dimension and a temporal motion map corresponding to the video clip.

12. The video representation self-supervised contrastive learning method according to claim 6, wherein a loss function corresponding to the motion alignment loss is represented as one or an accumulation of more of the following:
a distance between a first weighted accumulation of a feature map output by the last convolutional layer of the backbone network in all channels according to weights of the channels and a spatiotemporal motion map corresponding to the video clip;
a distance between a pooling result of the first weighted accumulation along the temporal dimension and a spatial motion map corresponding to the video clip; or
a distance between a pooling result of the first weighted accumulation along the spatial dimension and a temporal motion map corresponding to the video clip.

13. The video representation self-supervised contrastive learning method according to claim 6, wherein a loss function corresponding to the motion alignment loss is represented as one or an accumulation of more of the following:
a distance between a second weighted accumulation of gradients of channels of a feature map output by the last convolutional layer of the backbone network in all the channels according to weights of the channels and a spatiotemporal motion map corresponding to the video clip;
a distance between a pooling result of the second weighted accumulation along the temporal dimension and a spatial motion map corresponding to the video clip; or
a distance between a pooling result of the second weighted accumulation along the spatial dimension and a temporal motion map corresponding to the video clip.

14. The video representation self-supervised contrastive learning method according to claim 12, wherein the weight of the channel is determined by:
calculating a gradient of a similarity between a query sample and a positive sample corresponding to the video clip with respect to a channel of the feature map output by the convolutional layer, and calculating a mean of the gradient of the channel as the weight of the channel.

15. The video representation self-supervised contrastive learning method according to claim 6, wherein the contrastive loss is determined according to a loss function for the contrastive learning.

16. The video representation self-supervised contrastive learning method according to claim 15, wherein the loss function for the contrastive learning comprises an InfoNCE loss function.

17. The video representation self-supervised contrastive learning method according to claim 6, wherein the backbone network comprises a three-dimensional convolutional neural network.

18. The video representation self-supervised contrastive learning method according to claim 1, further comprising:
processing a video to be processed according to a learned video representation model to obtain a corresponding video feature.

19. A video representation self-supervised contrastive learning apparatus, comprising:
a memory; and
a processor coupled to the memory, the processor being configured to perform, based on instructions stored in the memory, the video representation self-supervised contrastive learning method, comprising:
calculating, according to optical flow information corresponding to each video frame of a video clip, a motion amplitude map corresponding to each video frame of the video clip;
determining, according to motion amplitude maps corresponding to the video frames of the video clip, motion information corresponding to the video clip; and
performing, according to a sequence of video clips and the motion information corresponding to each video clip, video representation self-supervised contrastive learning.

20. A non-transitory computer-readable storage medium stored a computer program which, when executed by a processor, implements the steps of the video representation self-supervised contrastive learning method; comprising:
calculating, according to optical flow information corresponding to each video frame of a video clip, a motion amplitude map corresponding to each video frame of the video clip;
determining, according to motion amplitude maps corresponding to the video frames of the video clip, motion information corresponding to the video clip; and
performing, according to a sequence of video clips and the motion information corresponding to each video clip, video representation self-supervised contrastive learning.
